(19) United States
(12) Patent Application Publication
(10) Pub. No.: US 2019/0292329 A1
(43) Pub. Date: Sep. 26, 2019

(54) METHODS OF REDUCING ODOR IN EXTRUDED LIGNIN AND EXTRUDED LIGNIN WITH REDUCED ODOR

(71) Applicant: Domtar Paper Company, LLC, Fort Mill, SC (US)

(72) Inventors: Mark DEANDREA, Waxhaw, NC (US); Michel Jean, Espanloa (CA)

(21) Appl. No.: 16/360,809

(22) Filed: Mar. 21, 2019

Related U.S. Application Data
(60) Provisional application No. 62/647,434, filed on Mar. 23, 2018.

(51) Int. Cl. C08H 7/00; B29B 9/06

(52) U.S. Cl. CPC C08H 6/00; B29B 9/06

(57) ABSTRACT

Methods of reducing odiferous compounds in lignin, and reduced-odor lignin produced by the present methods. A solvent, for example a polar solvent such as ethanol, may be mixed with lignin in an extruder to remove odiferous compounds such as mercaptans and phenolic compounds. The polar solvent can then be boiled or evaporated out of the mixture to extract the odiferous compounds from the lignin.

### CROSS-REFERENCE TO RELATED APPLICATIONS

This application claims the benefit of U.S. Provisional Application No. 62/647,434, filed Mar. 23, 2018, the contents of which is incorporated into the present application in its entirety.

### FIELD OF INVENTION

The present inventions relate generally to lignin such as Kraft lignin and, more particularly but not by way of limitation, to methods of reducing odor in extruded lignin and extruded lignins with reduced odor relative to similar lignins not subjected to the present methods.

### BACKGROUND

In general, lignin is a class of complex organic polymers that form structural materials in the support tissues of vascular plants and some algae. Chemically, lignins are cross-linked phenolic polymers. Lignin fills the spaces in the cell wall between cellulose, hemicellulose, and pectin components, especially in xylem tracheids, vessel elements, and sclereid cells. Lignin is covalently linked to hemicellulose and therefore crosslinks different plant polysaccharides, conferring mechanical strength to the cell wall and by extension the plant as a whole.

Lignin may be mixed with other polymers and molded to form plastic items and components. However, lignin typically has a perceptible odor that is undesirable for certain applications, such as, for example, interior automotive parts, food containers, and the like. For example, Kraft lignin has a sulfurous odor, due to the presence of odiferous compounds such as methyl mercaptans and guaiacol, that can be undesirable or unpleasant.

### SUMMARY

The present methods mix a polar solvent, for example ethanol, with lignin in an extruder to remove odiferous compounds such as mercaptans and phenolic compounds. For example, a polar solvent may be added to a barrel of a screw extruder and mixed with lignin to allow the polar solvent to bind with the odiferous compounds. The polar solvent can then be boiled out of the mixture to extract the odiferous compounds from the lignin and, for example, the gaseous polar solvent and odiferous compounds can be collected and/or removed from the barrel or mixing chamber, for example via vacuum collection.

In some of the present methods for reducing odiferous compounds in extruded lignin, the method comprises: mixing a source lignin and a solvent in an extruder such that the solvent binds with odiferous compounds in the source lignin; causing at least some of the solvent bound with the odiferous compounds to boil or evaporate to remove the bound odiferous compounds from the source lignin and thereby form a reduced-odor lignin having fewer odiferous compounds than the source lignin; extruding the reduced-odor lignin through an outlet of the extruder.

In some of the present methods for reducing odiferous compounds in extruded lignin, the lignin is introduced into the extruder through a hopper of the extruder.

In some of the present methods for reducing odiferous compounds in extruded lignin, the solvent is introduced into the extruder through a vent disposed between the hopper and the outlet and, optionally, where the vent is closer to the hopper than to the outlet.

In some of the present methods for reducing odiferous compounds in extruded lignin, the solvent comprises a polar solvent.

In some of the present methods for reducing odiferous compounds in extruded lignin, the polar solvent comprises ethanol and/or methanol.

In some of the present methods for reducing odiferous compounds in extruded lignin, the source lignin is dewatered and the dewatered source lignin has a solids content greater than 90% by weight. Some such methods further comprise: prior to mixing the dewatered source lignin and solvent in the extruder, dewatering the source lignin in the extruder. In some such methods, dewatering comprises: mixing a source lignin and a desiccant in an extruder such that the desiccant binds with water in the source lignin; causing at least some of the desiccant bound with the water to boil or evaporate to remove the bound water from the source lignin and thereby form a dewatered source lignin having less water than the source lignin; extruding the dewatered source lignin through an outlet of the extruder. In some such methods, the desiccant comprises glycerol.

In some of the present methods for reducing odiferous compounds in extruded lignin, the method further comprises: pelletizing the extruded reduced-odor lignin. In some such methods, the pelletizing is conducted in a wet pelletizer.

Some of the present reduced-odor lignins are produced by one of the present methods for reducing odiferous compounds in extruded lignin. Some such reduced-odor lignins are in pellet form.

Any embodiment discussed with respect to one embodiment of the invention applies to other embodiments of the invention as well and vice versa. Features described with reference to one embodiment should be understood to also be applicable to other embodiments. It is contemplated that features of any embodiment described herein can be implemented with respect to any of the present methods or compositions, and vice versa. Furthermore, the present compositions can be used in or to achieve the present methods.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the term “substantially” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Further, a device or system that is configured in a certain way is configured in at least that way, but it can also be configured in other ways than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 depicts a schematic, cutaway side view of a screw extruder of the type that can be used with the present methods of reducing odiferous compounds in extruded lignin.

FIG. 2 depicts a flowchart illustrating an embodiment of the present methods of reducing odiferous compounds in extruded lignin.

FIGS. 3A and 3B depict schematic side and persepective views, respectively, of an example of an extruder barrel configured for use in an example of the present methods of reducing odiferous compounds in extruded lignin.

### DETAILED DESCRIPTION OF ILLUSTRATIVE EMBODIMENTS

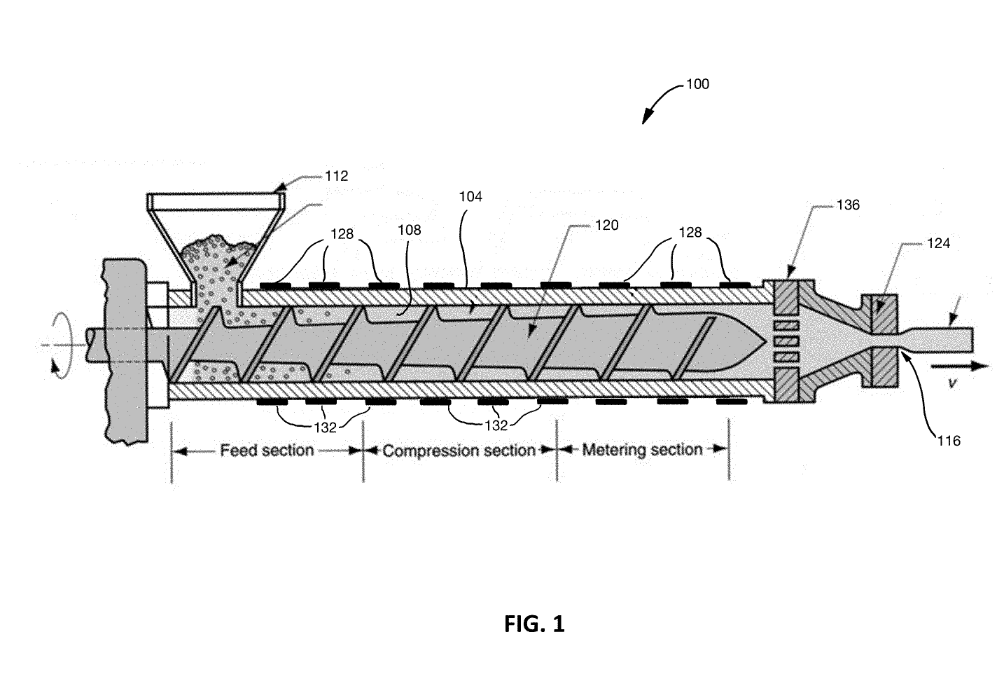

Referring now to the drawings and more particularly to FIG. 1, shown there and designated by the reference numeral 100 is a schematic, cutaway side view of a screw extruder of the type that can be used with the present methods of reducing odiferous compounds in extruded lignin. In the depicted embodiment, extruder 100 comprises a body 104 defining a mixing chamber or barrel 108, an inlet hopper 112, an outlet 116, and a screw 120 that is configured to rotate to mix components in the mixing chamber and advance the mixture from hopper 112 toward outlet 116 to extrude the mixture through a die 124 coupled to outlet 116. In the configuration shown, barrel 108 has a plurality of sections or segments and, in each such section or segment, body 104 defines a plurality of vents or ports 128 through which gas and/or material can flow into or out of barrel 108. In the depicted configuration, extruder 100 also includes a plurality of heaters 132 aligned with the segments or sections. Heaters 132 are configured to permit temperature control in a corresponding segment of the barrel, for example to heat, cool, or maintain the temperature of contents of the barrel in the corresponding segment. In some embodiments, extruder 100 may also comprise a breaker plate 136. While only a single screw is depicted, other extruder configurations may also be used, for example single-screw or dual-screw extruders.

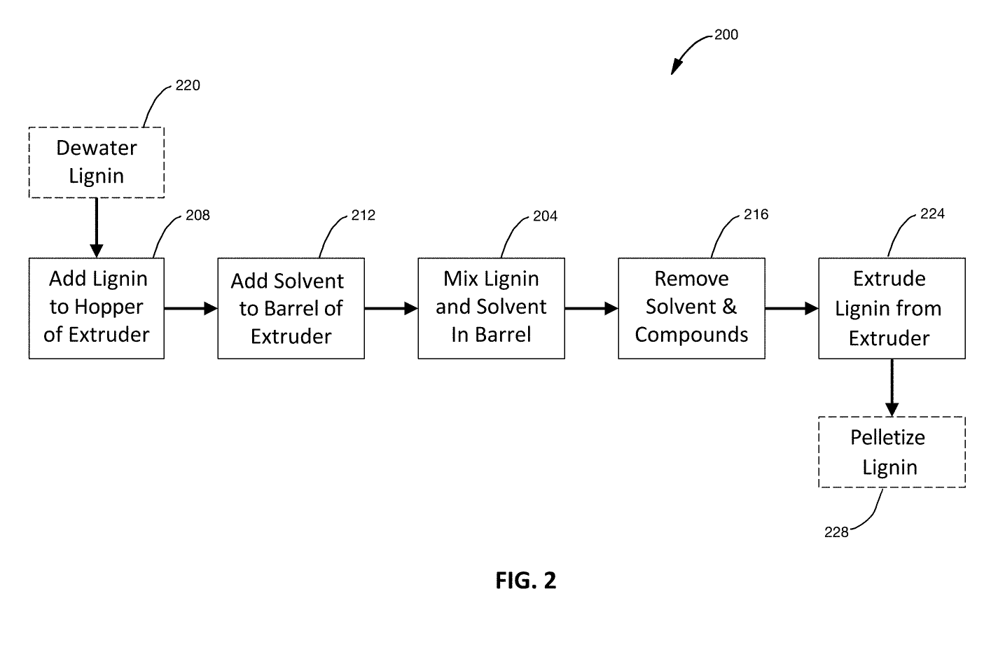

FIG. 2 depicts a flow chart depicting depicts a flowchart illustrating an embodiment 200 of the present methods of reducing odiferous compounds in extruded lignin, which can be understood with reference to extruder 100 depicted in FIG. 1.

In some of the present methods for reducing odiferous compounds in extruded lignin, the method comprises: a step 204 of mixing a source lignin 140 and a solvent 144 in an extruder, for example extruder 100, such that the solvent binds with odiferous compounds, for example mercaptans and phenolic compounds, in the source lignin. For example, source lignin 140 can be introduced at a step 208 into extruder 100 through hopper 112, and/or solvent 144 can introduced at a step 212 into extruder 100 through one of ports or vents 128, for example on of ports or vents 128 that is closer to the hopper than to the outlet. At a step 216, at least some of the solvent bound to the odiferous compounds can be removed to remove the bound odiferous compounds from the source lignin and thereby form a reduced-odor lignin having fewer odiferous compounds than the source lignin. For example, the temperature of the mixture can be increased or maintained to a point at which at least some of the solvent boils out of the mixture and/or the pressure in barrel 108 can be reduced below ambient pressure sufficiently to cause at least some of the solvent to evaporate out of the mixture. In one example, a segment or portion of the barrel into which the solvent is introduced may be maintained at a temperature below the boiling point of the solvent to permit liquid solvent to mix with the lignin, while a later segment or portion of the barrel closer to the exit is maintained at a temperature at or above the boiling point of the solid to cause at least a portion of the solvent to boil out of the mixture and thereby remove odiferous compounds. The gaseous solvent and odiferous compounds can then be removed from barrel 108 via venting and/or vacuum through one or more additional ones of ports or vents 128.

The source lignin may be “dewatered”—i.e., have a solids content of at least 90% by weight—prior to being introduced through hopper 112 for mixing with the solvent. In some embodiments, the dewatered source lignin has a solids content greater than any one of, or between any two of: 90 wt. %, 92 wt. %, 94 wt. %, 96 wt. %, 98 wt. %, and/or 99 wt. %. Some embodiments of the present methods comprise an optional step 220 of dewatering the source lignin prior to mixing the source lignin with the solvent. For example, the source lignin may be dewatered in an extruded, for example, the same extruder used to remove odiferous compounds. Such dewatering may comprise: mixing a source lignin and a desiccant in an extruder 100 such that the desiccant binds with water in the source lignin; causing at least some of the desiccant bound with the water to boil or evaporate, such as in barrel 108, to remove the bound water from the source lignin and thereby form a dewatered source lignin having less water than the source lignin; and extruding the dewatered source lignin through an outlet 116 and/or die 124 of the extruder. The desiccant may comprise glycerol.

The solvent may be a polar solvent, for example ethanol, methanol, butanol, propanol, and/or the like. The solvent may be mixed with the source lignin at a weight percent of solvent equal to any one of, or between any two of: 3 wt. %, 4 wt. %, 5 wt. %, 6 wt. %, 7 wt. %, 8 wt. %, 9 wt. %, 10 wt. %, 11 wt. %, 12 wt. %, 13 wt. %, 14 wt. %, 15 wt. %, 16 wt. %, 17 wt. %, 18 wt. %, 19 wt. %, and/or 20 wt. % of the source lignin.

The solvent may be introduced into the extruder at an elevated temperature i.e., a temperature above room temperature. For example, the solvent may be introduced at a temperature that is greater than any one of, or between any two of: 70%, 75%, 80%, 85%, 90%, and/or 95% of the solvent's boiling point under atmospheric pressure.

Additionally, the temperature profile along the mixing chamber or barrel of the extruder may be maintained in any suitable pattern, such as those included below for Example 1. While certain temperature profiles are included in Example 1 for both dewatering and/or removal of odiferous compounds that maintain an increasing temperature profile with a maximum below the atmospheric-pressure boiling points of the desiccant and solvent, respectively, the temperature profiles may be adjusted to more-rapidly and/or more-completely, or less-rapidly and/or less-completely, boil the respective desiccant or solvent, as long as the temperatures are managed to manage potential undesirable consequences. For example, the maximum temperatures may exceed the respective atmospheric-pressure boiling points as long as the temperatures are not high enough to damage extruder components, ignite solvents or other components, undesirably increase pressure inside the extruder, degrade the lignin, or cause undesirable environmental concerns.

Some embodiments of the present methods include an optional step 224 of extruding the reduced-odor lignin through outlet 116 and/or die 124 of the extruder. Such embodiments can also include pelletizing the reduced-odor lignin, for example by chopping an extruded portion of the reduced-odor lignin.

In some of the present embodiments, for example, the lignin can be or include Kraft lignin, which is extracted from black liquor; hydrolytic lignin; lignosulfonates; organosolv lignin; soda lignin; lignin obtained by pre-treatment of lignocellulosic material; or any mixture thereof. Pre-treatment of feedstocks can include alkaline or acid pre-treatment, pre-treatment with super-critical water, and/or the like. Such lignins in a composition can be chemically, physically, and/or biologically modified. Chemical modification of lignin can include, but is not limited to, the addition of one or more organic functional groups and/or one or more inorganic functional groups. Examples of such organic functional groups include carboxyl groups, carbonyl groups, alkenyl groups, and the like. Examples of such inorganic functional groups include sodium groups, sulfate groups, potassium groups, and the like. Physical modification of lignin can include, but is not limited to extraction, milling, and/or grinding. Biological modification of lignin can be performed by biomass degradation, or incubation with microbes or enzymes.

### I. EXAMPLES

The following examples as well as the figures are included to demonstrate preferred embodiments of the invention. It should be appreciated by those of skill in the art that the techniques disclosed in the examples or figures represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

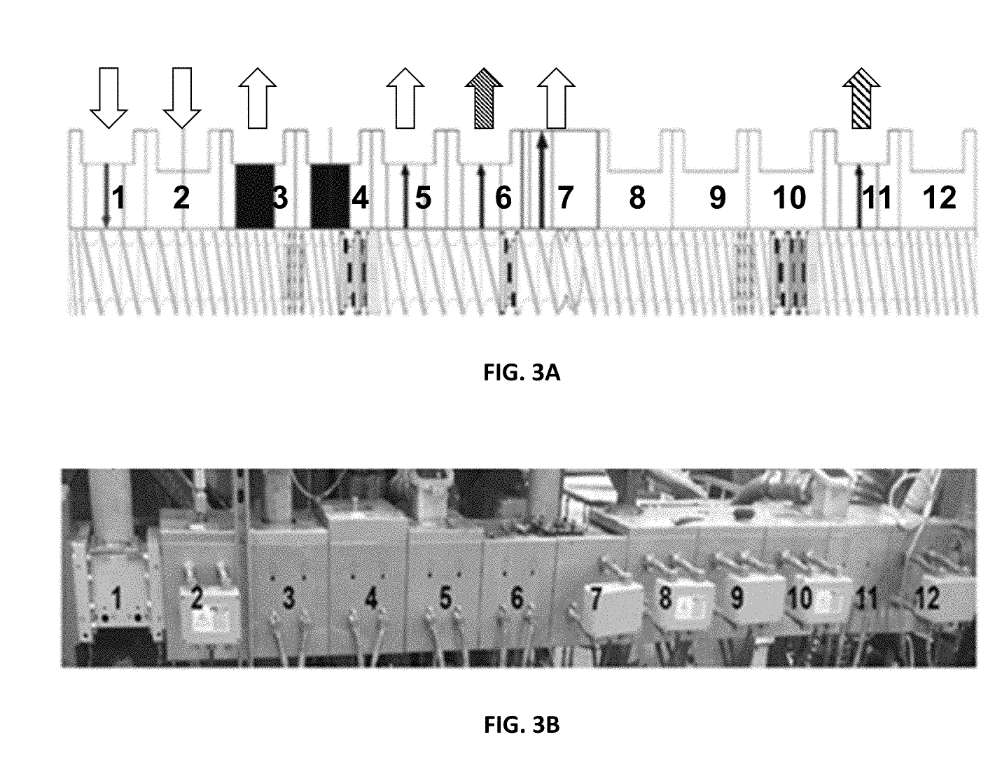

FIGS. 3A and 3B depict an extruder used to test the present methods of reducing odiferous compounds in extruded lignin. The extruder shown in FIGS. 3A and 3B is substantially similar in most respects to extruder 100 described with reference to FIG. 1. The body of extruder 100a includes twelve segments—numbered 1 to 12—defining the barrel, each segment having its own heater and vent or port. For purposes of the test procedures described here, port 1 corresponds to the hopper; ports 4, 8, 9, 10, and 12 were closed; ports 3, 5, and 7 were left open to atmosphere; vacuum was applied to port 6 (a pressure below atmospheric pressure); and partial vacuum was applied to port 11 (a pressure greater than that applied to port 6, but still below atmospheric pressure).

Kraft lignin with 65 wt. % solids content was obtained from Domtar's Plymouth mill.

The Kraft lignin was dewatered in the extruder by introducing the Kraft lignin into the hopper and mixing it with a desiccant, glycerol, introduced into the extruder via port 2. The screw was operated to mix the Kraft lignin and desiccant in the barrel to cause the desiccant to bind with the water in the Kraft lignin, and push the mixture through the barrel toward the outlet. The extruder body was maintained at the following temperature profile:

| | | | | | | | | | | | | |
|---|---|---|---|---|---|---|---|---|---|---|---|---|
| Segment | 1 | 2 | 3 | 4 | 5 | 6 | 7 | 8 | 9 | 10 | 11 | 12 |

| | | | | | | | | | | | |
|---|---|---|---|---|---|---|---|---|---|---|---|
| Temperature ° C. | 50 | 75 | 150 | 160 | 160 | 150 | 150 | 150 | 140 | 140 | 140 |

The increasing barrel temperature, mechanical agitation by the screw, vacuum at port 6, and/or partial vacuum at port 11 cooperated to cause at least some of the desiccant to boil and/or evaporate to remove the bound water—both of which were removed via ports 6 and 11, and to a lesser extent ports 3, 5, and 7—and the extruded, dewatered lignin exited the extruder with a solids content of 98 wt. %.

The dewatered lignin was then used a dewatered source lignin for removal of odiferous compounds.

Before removal of the odiferous compounds, the extruded was cleaned with pure ethanol, run through the hopper of the extruder until running clear through the outlet of the extruder.

Once the extruder was clean, the dewatered source lignin was then introduced into the extruder through the hopper and ethanol was introduced into the extruder through port 2.

The screw was operated to mix the dewatered source lignin and ethanol in the barrel to cause the ethanol to bind with the odiferous compounds in the dewatered source lignin, and push the mixture through the barrel toward the outlet. For a first batch, the ethanol was added at 17 wt. % of the dewatered source lignin. For a second batch, the ethanol was added at 5 wt. % of the dewatered source lignin. In each of the two batches, the ethanol was introduced at a temperature near its 78.4° C. boiling point under atmospheric pressure; in particular, the ethanol was introduced at a temperature of about 74° C.

The extruder body was maintained at the following temperature profile:

| | | | | | | | | | | | | |
|---|---|---|---|---|---|---|---|---|---|---|---|---|
| Segment | 1 | 2 | 3 | 4 | 5 | 6 | 7 | 8 | 9 | 10 | 11 | 12 |

| | | | | | | | | | | | |
|---|---|---|---|---|---|---|---|---|---|---|---|
| Temperature ° C. | 50 | 50 | 50 | 50 | 50 | 50 | 50 | 60 | 60 | 60 | 60 |

The increasing barrel temperature, mechanical agitation by the screw, vacuum at port 6, and/or partial vacuum at port 11 cooperated to cause at least some of the solvent to boil and/or evaporate to remove the bound odiferous compounds—both of which were removed via ports 6 and 11, and to a lesser extent ports 3, 5, and 7—and the extruded, reduced-odor lignin exited the extruder through the outlet/die.

Both batches of the extruded, reduced-odor lignin coming out of the extruder had a perceptibly reduced odor than the dewatered source lignin. For example, the extruded, reduced-odor lignin resembled tar and exhibited very shapeable, plastic behavior, was less brittle while cooling off, and was well fused with little to no visible air bubbles.

Samples of the extruded, reduced-odor lignin were rolled into elongated pieces and chopped into pellets. The pellets formed easily and maintained their shape.

The above specification and examples provide a complete description of the methods and compositions of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus-or step-plus-function limitations, unless such a limitation is explicitly recited in a given claim using the phrase(s) “means for” or “step for,” respectively.

1. A method for reducing odiferous compounds in extruded lignin, the method comprising:
mixing a source lignin and a solvent in an extruder such that the solvent binds with odiferous compounds in the source lignin;
causing at least some of the solvent bound with the odiferous compounds to boil or evaporate to remove the bound odiferous compounds from the source lignin and thereby form a reduced-odor lignin having fewer odiferous compounds than the source lignin;
extruding the reduced-odor lignin through an outlet of the extruder.

2. The method of claim 1, where the lignin is introduced into the extruder through a hopper of the extruder.

3. The method of any of claim 1, where the solvent is introduced into the extruder through a vent disposed between the hopper and the outlet and, optionally, where the vent is closer to the hopper than to the outlet.

4. The method of claim 1, where the solvent comprises a polar solvent.

5. The method of claim 4, where the polar solvent comprises ethanol.

6. The method of claim 1, where the source lignin is dewatered and the dewatered source lignin has a solids content greater than 90% by weight.

7. The method of claim 6, further comprising:
prior to mixing the dewatered source lignin and solvent in the extruder, dewatering the source lignin in the extruder.

8. The method of claim 7, where dewatering comprises
mixing a source lignin and a desiccant in an extruder such that the desiccant binds with water in the source lignin;
causing at least some of the desiccant bound with the water to boil or evaporate to remove the bound water from the source lignin and thereby form a dewatered source lignin having less water than the source lignin;
extruding the dewatered source lignin through an outlet of the extruder.

9. The method of claim 8, where the desiccant comprises glycerol.

10. The method of claim 1, further comprising:
pelletizing the extruded reduced-odor lignin.

11. The method of claim 10, where the pelletizing is conducted in a wet pelletizer.

12. A reduced-odor lignin produced by the method of claim 1.

13. The lignin of claim 12 in pellet form.
